(19) United States
(12) Patent Application Publication
(10) Pub. No.: US 2013/0227411 A1
(43) Pub. Date: Aug. 29, 2013

(54) SENSATION ENHANCED MESSAGING

(71) Applicants: Saumitra Mohan Das, San Jose, CA (US); Vinay Sridhara, Santa Clara, CA (US); Leonid Sheynblat, Hillsborough, CA (US)

(72) Inventors: Saumitra Mohan Das, San Jose, CA (US); Vinay Sridhara, Santa Clara, CA (US); Leonid Sheynblat, Hillsborough, CA (US)

(73) Assignee: QUALCOMM Incorporated, San Diego, CA (US)

(21) Appl. No.: 13/594,565

(22) Filed: Aug. 24, 2012

Related U.S. Application Data
(60) Provisional application No. 61/568,052, filed on Dec. 7, 2011.

(51) Int. Cl. H04L 12/58

(52) U.S. Cl. CPC H04L 51/00
USPC 715/702

(57) ABSTRACT

Methods, apparatuses, systems, and computer-readable media for providing sensation enhanced messaging are presented. According to one or more aspects, a computing device may receive an electronic message, and the electronic message may include sender-specified haptic data that identifies at least one non-vibratory haptic sensation to be provided to a recipient of the electronic message. Subsequently, the computing device may cause haptic feedback to be provided to a user based on the sender-specified haptic data. In at least one arrangement, the at least one non-vibratory haptic sensation may include one or more pressure characteristics, texture characteristics, wetness characteristics, adhesion characteristics, thermal characteristics, and/or movement characteristics.

### CLAIM OF PRIORITY UNDER 35 U.S.C. §119

This application claims priority to U.S. Provisional Application Ser. No. 61/568,052, filed Dec. 7, 2011, and entitled “Sensation Enhanced Messaging,” which is incorporated by reference herein in its entirety for all purposes.

### BACKGROUND

Aspects of the disclosure relate to computing technologies. In particular, aspects of the disclosure relate to mobile computing device technologies, such as systems, methods, apparatuses, and computer-readable media for providing sensation enhanced messaging.

Currently, some computing devices, such as cellular phones, smart phones, personal digital assistants (PDAs), tablet computers, and other mobile devices, may provide simple haptic feedback (e.g., tactile and/or touch-based feedback) in limited circumstances. For example, a cellular phone or smart phone may briefly vibrate to notify a user that a new text message has been received or that a phone call is incoming. However, this might be the full extent to which such a current device can provide haptic feedback. By implementing one or more aspects of the disclosure, enhanced functionality, greater convenience, and improved flexibility may be achieved, for instance, in providing haptic feedback to users of these and other computing devices.

### SUMMARY

Systems, methods, apparatuses, and computer-readable media for providing sensation enhanced messaging are presented. According to one or more aspects, “sensation-enhanced messaging” may include sending and/or receiving messages that include haptic data, where such haptic data may cause haptic feedback to be provided to a recipient of the message. As used herein, haptic feedback may include any kind of tactile and/or touch-based feedback, such as various texture sensations, pressure sensations, wetness sensations, adhesion sensations, thermal sensations, vibratory sensations, and/or any other effects that may be sensed by a person using his or her sense of touch. Furthermore, a “non-vibratory sensation,” as also used herein, may include any sensation that includes at least one effect that does not involve producing vibration. Examples of non-vibratory sensations include the texture sensations, pressure sensations, wetness sensations, adhesion sensations, and thermal sensations mentioned above, either alone, in combination with each other, or in combination with one or more vibratory sensations.

In one or more arrangements discussed herein, an electronic device, such as a smart phone, personal digital assistant, tablet computer, and/or any other kind of mobile computing device, may provide such haptic feedback using one or more electronically actuated mechanical, electrical, and/or electromechanical components. In one example, for instance, piezoelectric transducers may be used to simulate pinching, protrusions, punctures, textures, and/or other tactile sensations.

Some current devices may provide simple haptic feedback in limited circumstances (e.g., briefly vibrating to notify a user that a text message has been received or that a phone call is incoming). However, the functionalities included in current devices are limited not only in the types of haptic feedback that may be provided to a user, but also in the extent to which a user may customize the types of haptic feedback to be provided. By implementing one or more aspects of the disclosure, a sender of a message may be able to customize, suggest, and/or specify what type of haptic feedback should be provided to a recipient of the message, and the recipient of the message likewise may be able to customize how such haptic feedback is interpreted and provided by the recipient's device. Thus, while “sender-specified” haptic data may be created by a sender of a message and embedded into the message, the sender-specified haptic data might still be processed and interpreted by a recipient of the message (e.g., in accordance with the recipient's user preferences, device capabilities, etc.), such that haptic feedback provided to the recipient might be different from the haptic sensation originally specified by the sender. Advantageously, these and other features described herein may provide enhanced flexibility, convenience, and functionality in sensation-enhanced messaging applications and/or devices.

According to one or more aspects of the disclosure, a computing device may receive an electronic message, and the electronic message may include sender-specified haptic data that identifies at least one non-vibratory haptic sensation to be provided to a recipient of the electronic message. Subsequently, the computing device may cause haptic feedback to be provided to a user based on the sender-specified haptic data.

In one or more arrangements, the haptic feedback provided to the user may include the at least one non-vibratory haptic sensation identified by the sender-specified haptic data. In one or more additional and/or alternative arrangements, the haptic feedback provided to the user may be different than the at least one non-vibratory haptic sensation identified by the sender-specified haptic data.

According to one or more additional aspects, prior to causing haptic feedback to be provided, the computing device may determine, based on one or more user preferences, to provide at least one alternative haptic sensation instead of the at least one non-vibratory haptic sensation identified by the sender-specified haptic data. Additionally or alternatively, prior to causing haptic feedback to be provided, the computing device may determine, based on device capability information, to provide at least one alternative haptic sensation instead of the at least one non-vibratory haptic sensation identified by the sender-specified haptic data.

In one or more additional and/or alternative arrangements, prior to causing haptic feedback to be provided, the computing device may cause an indicator to be displayed, and the indicator may be configured to notify the user that haptic feedback is available. In addition, the haptic feedback may be caused to be provided to the user in response to the computing device receiving a user selection of the indicator.

In some instances, the sender-specified haptic data may have been generated by a sender's device that received a selection of the at least one non-vibratory haptic sensation from a menu. In additional and/or alternative instances, the at least one non-vibratory haptic sensation may include a protrusion in a particular shape, and the sender-specified haptic data may have been generated by a sender's device that received touch-based user input outlining the particular shape.

In one or more arrangements, the at least one non-vibratory haptic sensation may include one or more pressure characteristics, one or more texture characteristics, one or more wetness characteristics, one or more adhesion characteristics, one or more thermal characteristics, and/or one or more movement characteristics. In at least one additional and/or alternative arrangement, the sender-specified haptic data may include a haptic identifier corresponding to a particular non-vibratory haptic sensation.

### BRIEF DESCRIPTION OF THE DRAWINGS

Aspects of the disclosure are illustrated by way of example. In the accompanying figures, like reference numbers indicate similar elements, and:

FIGS. 1A and 1B illustrate an example device that may implement one or more aspects of the disclosure.

FIG. 2 illustrates an example method of providing sensation enhanced messaging according to one or more illustrative aspects of the disclosure.

FIG. 3 illustrates an example method of processing messages that include sensation information according to one or more illustrative aspects of the disclosure.

FIG. 4 illustrates an example of haptic feedback that may be provided by a device according to one or more illustrative aspects of the disclosure.

FIG. 5 illustrates an example method of composing a sensation-enhanced message according to one or more illustrative aspects of the disclosure.

FIG. 6 illustrates an example user interface for composing a sensation-enhanced message according to one or more illustrative aspects of the disclosure.

FIG. 7 illustrates an example data structure for transporting a sensation-enhanced message according to one or more illustrative aspects of the disclosure.

FIGS. 8A and 8B illustrate an example of a device displaying a sensation-enhanced message according to one or more illustrative aspects of the disclosure.

FIG. 9 illustrates an example computing system in which one or more aspects of the disclosure may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

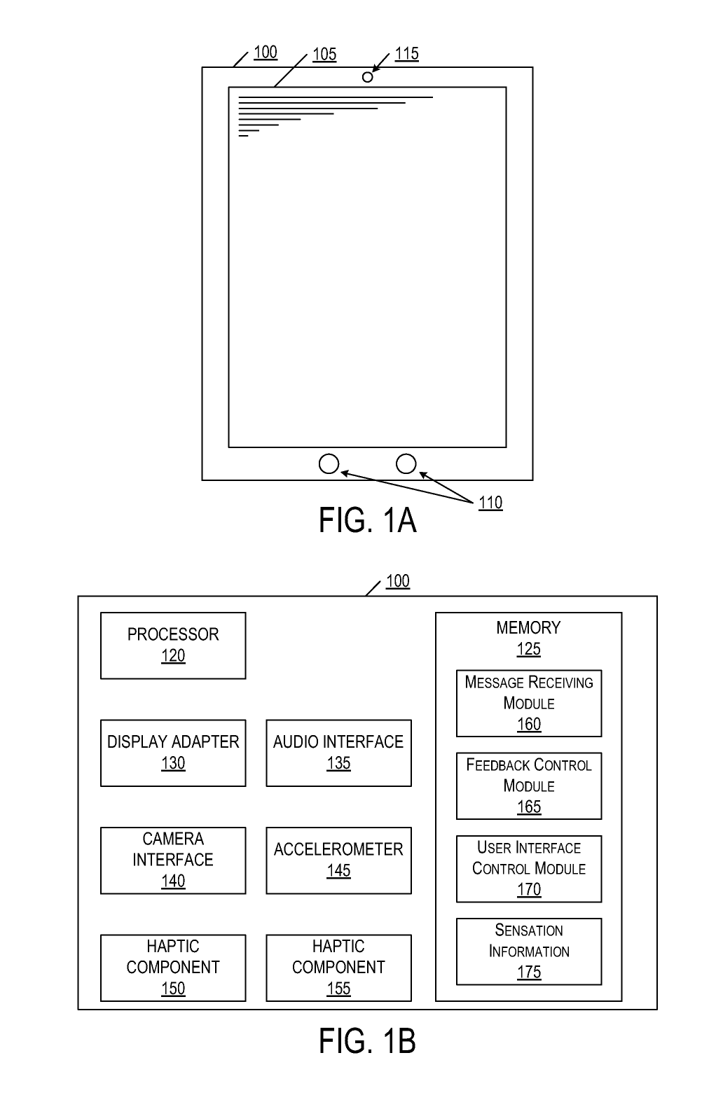

FIGS. 1A and 1B illustrate an example device that may implement one or more aspects of the disclosure. As seen in FIG. 1A, for example, computing device 100 may include one or more components, such as a display 105, buttons and/or keys 110, and/or a camera 115. In one or more arrangements, display 105 may be a touch screen, such that a user may be able to provide touch-based user input to computing device 100 via display 105. In addition, a user may be able to provide tactile user input to computing device 100 by touching, interacting with, engaging, and/or otherwise stimulating one or more haptic sensors included in (and/or otherwise communicatively coupled to) computing device 100, such as those illustrated in FIG. 1B.

As seen in FIG. 1B, for example, computing device 100 may include a plurality of internal components. For example, computing device 100 may include one or more processors (e.g., processor 120), one or more memory units (e.g., memory 125), at least one display adapter (e.g., display adapter 130), at least one audio interface (e.g., audio interface 135), one or more camera interfaces (e.g., camera interface 140), one or more motion sensors (e.g., one or more accelerometers, such as accelerometer 145, one or more gyroscopes, one or more magnetometers, etc.), and/or other components.

In addition, computing device 100 may further include one or more haptic components, such as haptic component 150 and haptic component 155. According to one or more aspects, each of haptic component 150 and haptic component 155 may be and/or include one or more piezoelectric transducers, and/or one or more other components capable of and/or configured to produce various forms of haptic feedback.

In some arrangements, the one or more haptic components included in computing device 100 (e.g., haptic component 150, haptic component 155, etc.) may be the same type of component and/or may produce the same form of haptic feedback (e.g., texture sensations, wetness sensations, thermal sensations, etc.), while in other arrangements, the one or more haptic components included in computing device 100 may be different types of components and/or or may produce different forms of haptic feedback. Additionally or alternatively, the one or more haptic components included in computing device 100 may operate individually and/or in combination to produce a plurality of different tactile effects. Although these haptic components (e.g., haptic component 150, haptic component 155, etc.) are described as being “included in” computing device 100, it should be understood that these haptic components might not necessarily be inside of computing device 100. For example, it is contemplated that in some arrangements, one or more of these haptic components may be disposed along exterior surfaces of computing device 100. Additionally or alternatively, any and/or all of these haptic components may be incorporated into and/or provided as part of one or more peripheral accessories, which, for instance, may be communicatively coupled to computing device 100 (e.g., via one or more wireless and/or wired connections).

In some embodiments, memory 125 may store one or more program modules, as well as various types of information, that may be used by processor 120 and/or other components of device 100 in providing the various features and functionalities discussed herein. For example, memory 125 may, in some embodiments, include a message receiving module 160, which may enable device 100 to receive an electronic message. In some instances, the electronic message received by message receiving module 160 may include sender-specified haptic data that identifies at least one non-vibratory haptic sensation to be provided to a recipient of the electronic message (e.g., a user of device 100).

In some embodiments, memory 125 may further include a feedback control module 165. Feedback control module 165 may, for instance, enable device 100 to cause haptic feedback to be provided based on the sender-specified haptic data included in the electronic message received by message receiving module 160. For example, feedback control module 165 may cause haptic components 150 and 155 to provide haptic feedback to a user of device 100. As another example, feedback control module 165 may, in some instances, enable device 100 to cause haptic feedback to be provided that is different from the sender-specified haptic data included in the electronic message received by message receiving module 160 (e.g., based on user preferences and/or other settings associated with haptic feedback).

In some embodiments, memory 125 may further include a user interface control module 170. User interface control module 170 may, for instance, enable device 100 to display an indicator (e.g., using display adapter 130), and in some instances, the indicator may be configured to notify a user of device 100 that haptic feedback is available (e.g., with respect to particular content being displayed on device 100, such as the electronic message received by message receiving module 160). In addition, user interface control module 170 may be configured to receive and/or process user input (e.g., received from a user of device 100). This may, for example, enable haptic feedback to be provided by device 100 in response to a user selection of an indicator provided by user interface control module 170.

In some embodiments, memory 125 also may store sensation information 175. Sensation information 175 may, for instance, include information that defines one or more predefined haptic feedback sensations, one or more user-defined haptic feedback sensations, and/or one or more other haptic feedback sensations. For example, sensation information 175 may include various haptic data, such as the haptic data discussed in greater detail below, and this haptic data may be used by device 100 in providing haptic feedback.

While the program modules discussed above are described as being included in memory 125, in some additional and/or alternative embodiments, these modules (e.g., message receiving module 160, feedback control module 165, and/or user interface control module 170) can be provided by processor 120, by one or more separate and/or individual processors, and/or by other hardware components instead of and/or in addition to those discussed above. For example, in some embodiments, message receiving module 160 may be provided as and/or by a first processor, feedback control module 165 may be provided as and/or by a second processor, and user interface control module 170 may be provided as and/or by a third processor.

Having described an example of a computing device 100 in which various aspects of the disclosure may be implemented, for instance, to provide sensation enhanced messaging to one or more users, several example methods that may be performed and/or otherwise implemented to provide sensation enhanced messaging and/or process messages that include sensation information will now be described.

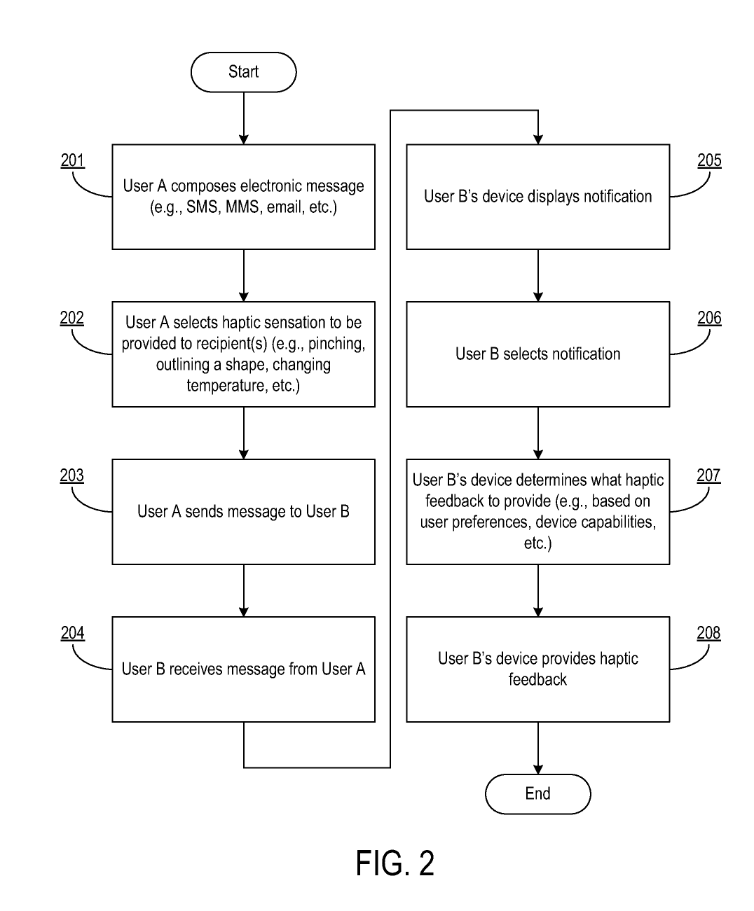

FIG. 2 illustrates an example method of providing sensation enhanced messaging according to one or more illustrative aspects of the disclosure. In step 201, a first user (e.g., “User A”) may compose an electronic message, for instance, using a mobile computing device, such as a smart phone or tablet computer. The electronic message may be a SMS text message, a MMS text message, an email message, and/or any other type of electronic message.

Subsequently, in step 202, the first user may select a haptic sensation to be provided to one or more recipients of the electronic message. The selected haptic sensation may include one or more types of haptic feedback sensations (e.g., texture sensations, pressure sensations, etc.). In one embodiment, the first user's computing device may display a menu in which various haptic feedback sensations are listed (e.g., a pinch, a poke, a change in temperature, a shape to be outlined, etc.), and the first user may select a haptic sensation to be provided to one or more recipients of the electronic message by selecting one or more options from the menu. In another embodiment, the first user's computing device may display a user interface in which the first user may draw (e.g., by providing touch-based user input to a touch screen included in the first computing device) an outline of a shape to be provided as haptic feedback to one or more recipients of the electronic message.

In step 203, the first user may send the electronic message to the one or more recipients. The electronic message may be sent by the first user's device in accordance with the particular protocol specified by the first user (e.g., SMS, MMS, email, etc.) and haptic data identifying the haptic sensation to be provided to the one or more recipients may be embedded in the electronic message.

In step 204, at least one recipient (e.g., a “second user” or “User B”) of the one or more recipients may receive the electronic message. In particular, a second user's computing device may receive and process the electronic message and the haptic data embedded in the electronic message.

In step 205, the second user's computing device may display a notification indicating that haptic feedback is available. The notification may, for example, include an icon indicating that a message that includes embedded haptic data has been received.

In step 206, the second user may select the displayed notification. The second user's computing device may receive the selection as user input and may interpret the selection as a request to view the electronic message and/or play back the haptic sensation identified by the haptic data embedded in the electronic message.

In step 207, the second user's computing device may determine, based on the haptic data embedded in the electronic message, what haptic feedback should be provided to the second user. In one embodiment, the second user's computing device may determine that the haptic feedback to be provided to the second user should include the haptic sensation identified by the haptic data and specified by the sender of the electronic message (e.g., the first user). In another embodiment, the second user's computing device may determine that different haptic feedback than that identified by the haptic data and specified by the sender of the electronic message should be provided. In some instances, this determination may be based on preferences set by the second user (e.g., specifying that certain types of haptic feedback should be provided instead of others, for instance, that thermal sensations should be provided instead of pinching sensations). Additionally or alternatively, this determination may be based on information describing the capabilities of the user's device (e.g., the second user's computing device may include transducers to simulate adhesion sensations, but might not include transducers to simulate thermal sensations).

Subsequently, in step 208, the second user's computing device may provide the haptic feedback to the second user. As described above, this haptic feedback may be provided to the second user by electronically actuating one or more transducers and/or other components in order to create the desired effect or effects. Additionally or alternatively, the haptic feedback provided to the second user may include or differ from the haptic sensation specified by the sender of the message (e.g., because the second user's computing device determined in step 207 that different haptic feedback should be provided).

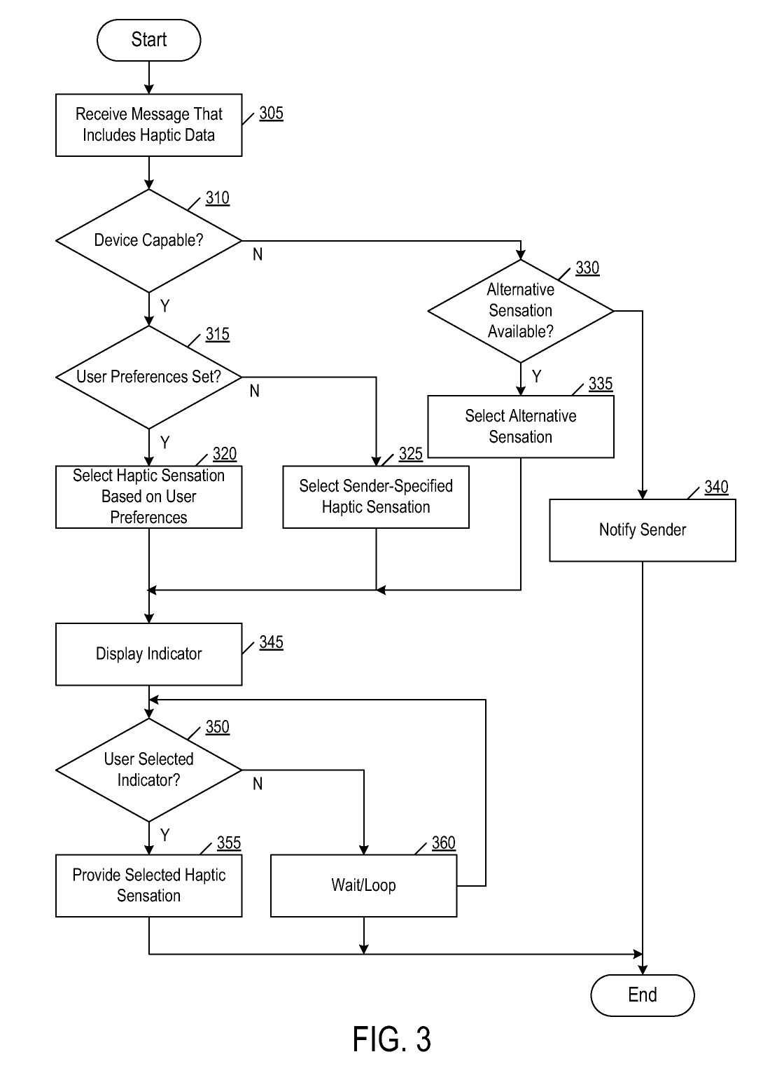

FIG. 3 illustrates an example method of processing messages that include sensation information according to one or more illustrative aspects of the disclosure. According to one or more aspects, any and/or all of the methods and/or method steps described herein may be performed by a computing device, such as computing device 100, and/or may be implemented as computer-executable instructions, such as computer-executable instructions stored in a memory of an apparatus and/or computer-executable instructions stored in a computer-readable medium.

In step 305, a message that includes haptic data may be received. For example, in step 305, computing device 100 may receive a message that includes haptic data. In one or more arrangements, the message may be a Short Message Service (SMS) text message, a Multimedia Messaging Service (MMS) message, or an email message. While these types of messages are listed here as examples, it should be understood that the message received in step 305 could be any type of electronic message or other electronic communication.

In at least one arrangement, computing device 100 may receive a plurality of messages in step 305. For example, computing device 100 may receive a plurality of SMS messages that together form a single, concatenated SMS message. In some instances, a concatenated SMS message may be used to encode haptic information in an SMS message, as character count limits associated with SMS messages might otherwise interfere with or prevent encoding the haptic information in the SMS message. Accordingly, a concatenated SMS message received by computing device 100 in step 305 may include encoded haptic information, which may be used by computing device 100 in providing haptic feedback to a user, as described below.

In one or more arrangements, the haptic data included in the message received in step 305 may specify one or more non-vibratory haptic sensations to be provided to a recipient of the message. As discussed above, a non-vibratory haptic sensation may include any sensation that includes at least one effect that does not involve producing vibration. Examples of non-vibratory sensations include texture sensations, pressure sensations, wetness sensations, adhesion sensations, and thermal sensations, produced either alone, in combination with each other, or in combination with one or more vibratory sensations. For example, a texture sensation or a protrusion effect produced either alone or in combination (e.g., with each other) could be considered non-vibratory haptic sensations. As another example, a protrusion effect and a vibration sensation produced in combination (e.g., with each other) could be considered a non-vibratory haptic sensation, whereas the vibration sensation produced on its own might not be considered a non-vibratory haptic sensation.

In one example, the haptic data included in the message received in step 305 may specify one or more slip effects and/or one or more adhesion effects to be provided to a recipient of the message. The slip effects and/or adhesion effects specified by the haptic data included in the message can, for example, allow one person to share tactile properties of an object, such as the object's texture, with another person. An example application of this functionality is an instance in which one person is at a store shopping for goods, such as fabric or carpet, and wishes to share the texture of the goods with another person who is not at the store. In accordance with various aspects of the disclosure, the texture of the fabric or carpet can be captured and/or modeled in haptic data by the device of the user at the store (e.g., by recording or otherwise capturing the actual texture of the fabric or carpet by the device of the user at the store, by prompting the user to select a predefined or template texture to be used as the modeled texture of the fabric or carpet, etc.), and this haptic data can then be sent in a message to the other user, whose device may receive the message and subsequently provide haptic effects to the recipient user based on the haptic data, as discussed below.

In step 310, it may be determined whether the device is capable of providing the one or more haptic sensations defined by the haptic data included in the received message. For example, in step 310, computing device 100 may determine whether it is capable of providing the one or more haptic sensations defined by the haptic data included in the received message and/or otherwise specified by the sender of the message. In some instances, computing device 100 may make this determination based on information specifying what haptic components are included in computing device 100 and/or otherwise communicatively coupled to computing device 100 (e.g., such that these haptic components may be used by computing device 100 to provide one or more haptic feedback sensations to a user of computing device 100).

If it is determined, in step 310, that the device is capable of providing the one or more haptic sensations defined by the haptic data included in the received message, then in step 315, it may be determined whether one or more user preferences have been set, such as one or more preferences specifying how haptic feedback is to be provided. For example, in step 315, computing device 100 may determine whether one or more haptic feedback preferences have been set. Such haptic feedback preferences may specify, for instance, that certain sensations (e.g., thermal sensations) are to be provided in place of other sensations (e.g., adhesions sensations), that some sensations (e.g., pinching sensations) are not to be provided at all, and/or that other user-specified rules should be followed in providing haptic feedback. Advantageously, by allowing a user to set preferences related to haptic feedback, computing device 100 may enable a user to control and/or override haptic feedback that would otherwise be specified by a sender of the message that includes the haptic data.

If it is determined, in step 315, that one or more user preferences have been set, such as one or more preferences specifying how haptic feedback is to be provided, then in step 320, one or more haptic sensations may be selected to be provided based on both the haptic data included in the message and the one or more user preferences. For example, in step 320, computing device 100 may select one or more haptic sensations to be provided to a user of computing device 100. If, for instance, the sender-specified sensation(s) defined by the haptic data included with the message are not modified, limited, and/or overridden by the user preferences, then in step 320, computing device 100 may select the sender-specified sensation(s) to be provided to a user of the computing device 100. Alternatively, if, for instance, the user preferences specify that one or more of the sender-specified sensation(s) should not be performed and/or that one or more alternative sensation(s) should instead be provided, then in step 320, computing device 100 may select one or more alternative sensation(s) to be provided to the user of the computing device 100 (or computing device 100 may select that no sensation(s) are to be provided to the user of the computing device 100). Subsequently, the method may proceed to step 345, which is further described below.

On the other hand, if it is determined, in step 315, that one or more user preferences have not been set, such as one or more preferences specifying how haptic feedback is to be provided, then in step 325, the one or more haptic sender-specified sensations (e.g., defined by the haptic data included in the message) may be selected to be provided. For example, in step 325, computing device 100 may select the one or more sensations specified in the message (e.g., defined by the haptic data) as the one or more sensations to be provided to the user as haptic feedback. Subsequently, the method may proceed to step 345, which is further described below.

If, on the other hand, it is determined in step 310 that the device is not capable of providing the one or more haptic sensations defined by the haptic data included in the received message, then in step 330, it may be determined whether an alternative sensation is available to be provided. For example, in step 330, computing device 100 may determine whether it is capable of providing an alternative sensation (e.g., using the one or more haptic components that are available to computing device 100). In at least one arrangement, computing device 100 may make this determination based on information correlating one or more haptic sensations with one or more alternative haptic sensations. For example, computing device 100 may load a data table provided, for instance, by a manufacturer of the computing device 100, in which this correlation information is stored. As one example, such a data table may specify that thermal effects are to be provided in place of adhesion effects, for instance, because the particular device (e.g., computing device 100) might not include haptic components to reproduce adhesion effects.

If it is determined, in step 330, that an alternative sensation is available to be provided, then in step 335, the alternative sensation may be selected to be provided (e.g., instead of the sender-specified haptic sensation defined by the haptic data included in the message). For example, in step 335, computing device 100 may select the one or more alternative sensations determined to be available in step 330 as the one or more haptic sensations to be provided to the user. Subsequently, the method may proceed to step 345, which is further described below.

On the other hand, if it is determined, in step 330, that an alternative sensation is not available to be provided, then in step 340, the message sender may be notified that the haptic feedback could not be provided to the particular recipient. For example, in step 340, computing device 100 may send a message or other communication to the sender notifying the sender that the haptic feedback could not be reproduced by computing device 100. This may allow the sender to understand the capabilities of the recipient device (e.g., computing device 100), for instance, in sending future messages to the recipient.

In step 345, an indicator may be displayed, and the indicator may notify the user that one or more haptic sensations associated with the message are available for play back. For example, in step 345, computing device 100 may display (e.g., on display 105) an icon indicating that haptic sensations associated with the message are available. As described below, the indicator may operate such that the haptic sensations are provided when and/or shortly after a user selects the indicator (e.g., by clicking on the indicator with a mouse, by tapping on the indicator when displayed on a touch screen, etc.).

Subsequently, in step 350, it may be determined whether the user has selected the indicator. For example, in step 350, computing device 100 may determine whether it has received user input corresponding to a selection of the indicator.

If it is determined, in step 350, that the user has selected the indicator, then in step 355, the one or more haptic sensations (e.g., selected in step 320, step 325, or step 335) may be provided. For example, in step 350, computing device 100 may provide the one or more haptic sensations previously selected by the computing device 100 to be provided to the user (e.g., in step 320, step 325, or step 335). Additionally or alternatively, computing device 100 may provide such haptic sensations using one or more haptic components included in and/or communicatively coupled to computing device 100.

On the other hand, if it is determined, in step 360, that the user has not selected the indicator, then the device (e.g., computing device 100) may wait and/or loop for a predetermined period of time (e.g., to provide the user with the opportunity to select the indicator and/or play back the haptic feedback), and subsequently, the method may end.

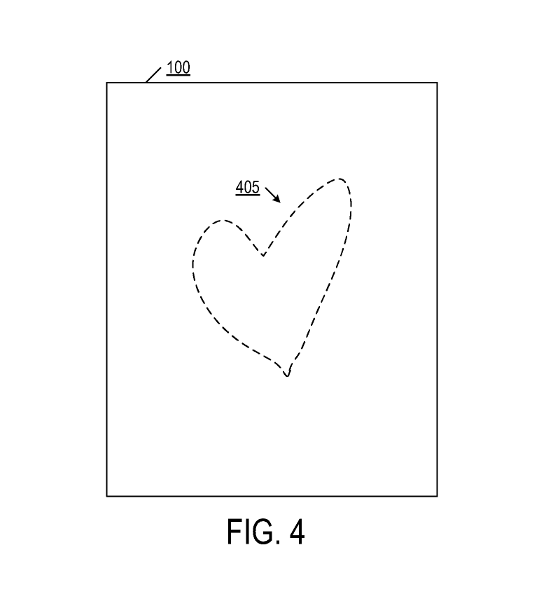

FIG. 4 illustrates an example of haptic feedback that may be provided by a device according to one or more illustrative aspects of the disclosure. For instance, as described above, a shape or other outline may be “drawn” on a user's palm (e.g., by computing device 100 via one or more haptic components) in providing haptic feedback to the user. In one or more configurations, “drawing” such a shape or outline may involve modulating one or more haptic components to create one or more protrusions that form the desired shape or outline. As seen in FIG. 4, one example of providing this type of haptic feedback may include producing an outline 405 in the shape of a heart on an exterior surface of computing device 100. In this example, if a user were to grasp the computing device 100 in their hand, the user would be able to feel (e.g., using their sense of touch) the protrusion of the outline 405. While an outline of a heart is illustrated and described as an example here, any other shape or outline could be similarly produced and provided as haptic feedback, as desired.

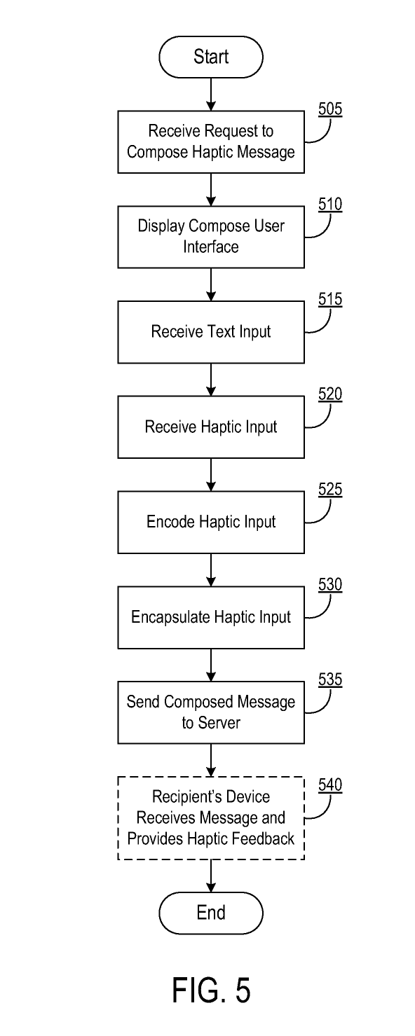

FIG. 5 illustrates an example method of composing a sensation-enhanced message according to one or more illustrative aspects of the disclosure. Like the example method described above, the example method illustrated in FIG. 5 (and/or any of the method steps thereof) may be performed by a computing device, such as computing device 100, and/or may be implemented as computer-executable instructions, such as computer-executable instructions stored in a memory of an apparatus and/or computer-executable instructions stored in a computer-readable medium.

In step 505, a request to compose a haptic message, which may also be referred to as a “sensation-enhanced” message, may be received. For example, in step 505, the computing device 100 may receive a request from a user of the computing device 100 to compose a haptic message. In one example, such a request may be received by the computing device 100 as a user selection of a menu item, such as a menu item displayed by and/or otherwise provided as part of a messaging application executed on and/or otherwise provided by the computing device 100.

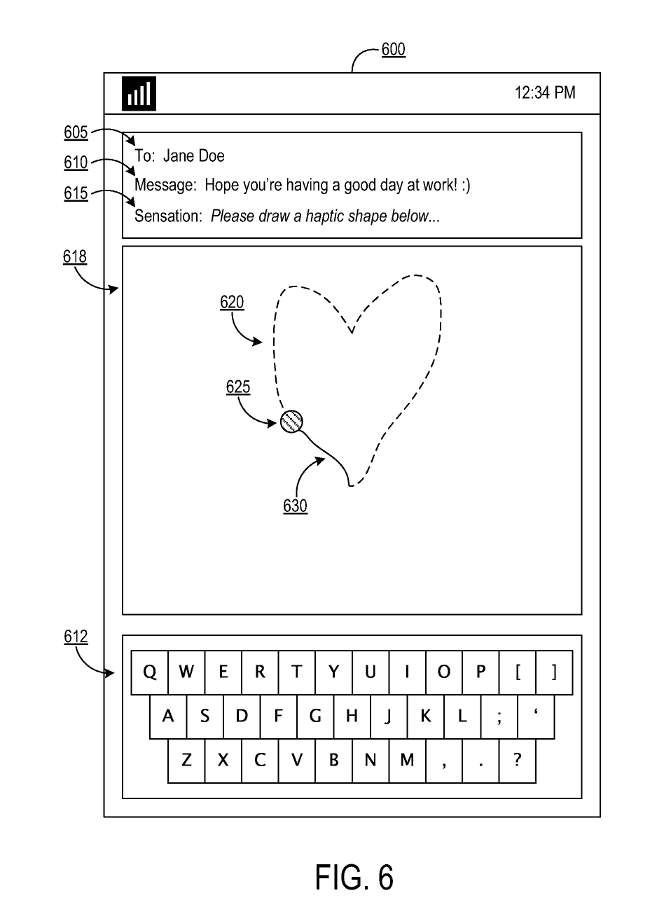

In step 510, one or more user interfaces for composing a sensation-enhanced message may be displayed. For example, in step 510, the computing device 100 may display the example user interface illustrated in FIG. 6, which is discussed in greater detail below.

Referring again to FIG. 5, in step 515, text input may be received. The text input may, for instance, specify a message that the user of the computing device 100 would like to compose and/or send to one or more recipients and/or one or more recipient devices. For example, in step 515, the computing device 100 may receive text input via an on-screen keyboard displayed as part of the user interface, which may be displayed by the computing device 100 on a touch-screen or other touch-sensitive display device incorporated into and/or communicatively coupled to the computing device 100. Additionally or alternatively, the computing device 100 may receive text input via a physical keyboard, which includes one or more physical buttons and/or keys, and which is incorporated into and/or communicatively coupled to the computing device 100.

In step 520, haptic input may be received. The haptic input may, for instance, specify one or more haptic sensations that the user of the computing device 100 would like to include in the sensation-enhanced message, where such haptic sensations are to be provided to the one or more recipients of the message via the one or more recipient devices. In some arrangements, the haptic input may be received as a user selection of a menu item, while in other arrangements, the haptic input may be received as touch-based user input that defines one or more lines and/or one or more shapes to be reproduced as protrusions on and/or otherwise be provided to the one or more recipients and/or recipient devices. For example, as seen in FIG. 6, which is discussed in greater detail below, a user may draw a shape (e.g., a heart, a star, a triangle, a “thumbs-up” outline, etc.) on a display, and the computing device may receive and record the shape so that it can be reproduced as tactile haptic feedback to one or more recipients via the one or more recipient devices.

In one or more arrangements, the haptic input received in step 520 may include a plurality of haptic sensations that are to be provided with the sensation-enhanced message being composed. For example, the haptic input may include a first sensation that includes producing edges and/or protrusions in a particular shape (e.g., a heart), and the haptic input further may include a second sensation that includes producing a thermal effect (e.g., a warming sensation).

In some embodiments, haptic input may be received as a tactile impression. For instance, in one example, a user of the computing device 100 may provide haptic input to the device in the form of a tactile impression by pressing the device with their palm (e.g., in contrast to poking the device) or by kissing a surface of the device. This may enable the user to cause corresponding haptic feedback to be provided to one or more recipients of the message. In some additional and/or alternative embodiments, haptic input may be received as a gesture or a series of gestures. For instance, in one example, a user of the computing device 100 may perform a gesture, which may be detected by the computing device 100 using one or more sensors. In some instances, the computing device 100 may detect a gesture or a series of gestures by capturing one or more images of the user (or a portion of the user, such as the user's hand or hands) and analyzing the one or more images to identify particular positions or motions corresponding to particular gestures. In some additional and/or alternative embodiments, haptic input may be received from an accessory or peripheral of the computing device that captured sensation input provided by the user. For example, haptic input may be received from a wand accessory that is configured to capture sensation input, such as texture and temperature, to be reproduced as haptic feedback.

In step 525, the received haptic input may be encoded. For example, in step 525, the computing device 100 may encode the haptic input received in step 520 by transforming the haptic input into haptic data representing the one or more haptic sensations to be provided to the one or more recipients of the message being composed. For example, if the haptic input received in step 520 includes a sensation that includes producing edges and/or protrusions in a particular shape (e.g., a heart, a star, a triangle, a “thumbs-up” outline, etc.), then the computing device 100 may transform the haptic input into data representing the haptic sensation by determining one or more vectors and/or one or more points that define the outline of the shape and subsequently storing the determined vectors and/or points (e.g., in a data table or other data structure stored in memory, such as the memory of the computing device 100). In another example, if the haptic input received in step 520 includes a sensation that includes producing a thermal effect (e.g., a warming sensation, a cooling sensation, etc.), then the computing device 100 may transform the haptic input into data representing the haptic sensation by determining one or more parameters that define the magnitude and duration, for instance, of the thermal effect and subsequently storing the one or more determined parameters (e.g., in a data table or other data structure stored in memory, such as the memory of the computing device 100).

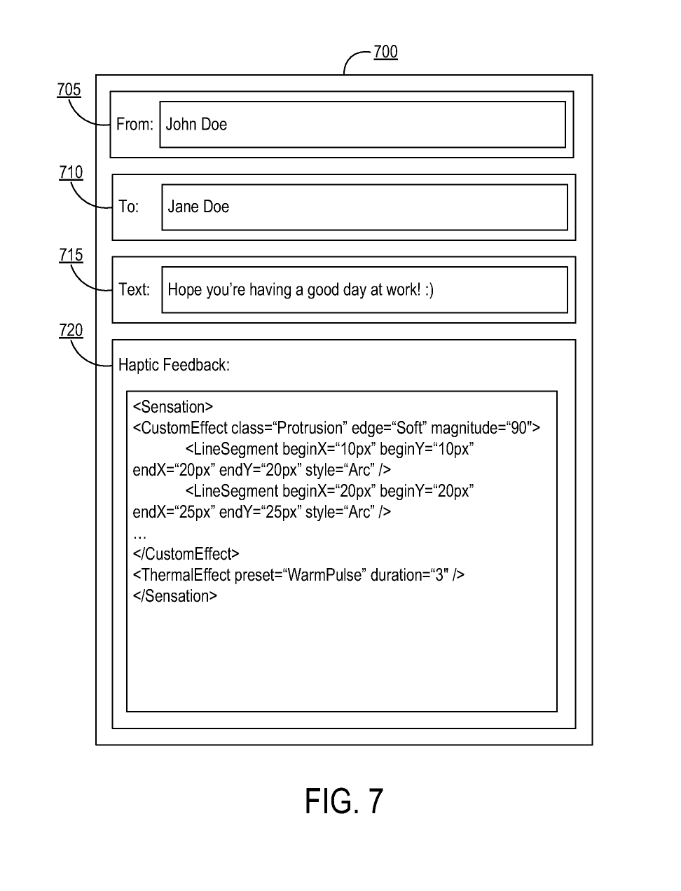

In step 530, the encoded haptic input may be encapsulated. For example, in step 530, the computing device 100 may encapsulate the encoded haptic input by creating a data structure to contain the encoded haptic input (e.g., in addition to other information related to the message being composed) and by storing the encoded haptic input in the data structure, along with the other information related to the message. In one or more arrangements, such a data structure may take the form of the example data structure illustrated in FIG. 7, which is described in greater detail below. While this data structure is discussed below as an example of how haptic data may be encoded and capsulated, any desirable transport mechanism may be used, and haptic data may be encoded and encapsulated in any appropriate manner. In some arrangements, data may be packaged and compressed for transport between various devices. Particular transport mechanisms also may be selected based on the devices sending and receiving the haptic data. In other words, in some embodiments, haptic input may be encoded and encapsulated based on information specifying the capabilities or other properties of the one or more devices that are to provide haptic feedback based on the haptic input.

Referring again to FIG. 5, in step 535, the composed message may be sent to a message server. For example, in step 535, the computing device 100 may send the composed message to a message server by sending the data structure created in step 530 to the message server. In one or more additional or alternative arrangements, the composed message may be sent as a peer-to-peer message from the computing device 100 directly to one or more recipient devices (e.g., which may be communicatively coupled to the same network as the computing device 100). In some embodiments, peer-to-peer messaging functionalities may be built on top of existing peer-to-peer platforms and/or protocols, which may define syntax, classes, methods, and/or other features for sending and receiving such messages. In some arrangements, such platforms and/or protocols further may provide functions that enable one device (e.g., the computing device 100) to discover other nearby and/or otherwise available devices for receiving peer-to-peer messages.

Subsequently, in step 540, a recipient's device may receive the message and provide haptic feedback based on the haptic data included in and/or otherwise associated with the message. For example, in step 540, a recipient's device may perform one or more steps of the example method illustrated in FIG. 3, as discussed above, to receive the sensation-enhanced message and provide haptic feedback.

FIG. 6 illustrates an example user interface for composing a sensation-enhanced message according to one or more illustrative aspects of the disclosure. According to one or more aspects, any and/or all of the example user interfaces and/or user interface elements discussed herein may be displayed by a computing device, such as computing device 100, on a display screen, such as display 105.

In one or more arrangements, an example user interface 600 for composing a sensation-enhanced message may include a recipient selection menu 605 via which a user may select and/or otherwise specify one or more recipients for the message being composed. In addition, the user interface 600 may include a text entry region 610 via which a user may provide text and/or character input to be included in the message being composed (e.g., by selecting one or more characters via on-screen keyboard 612), as well as a sensation selection menu 615 via which a user may select and/or otherwise specify haptic feedback to include in the message being composed. For example, sensation selection menu 615 may include one or more menu options corresponding to one or more predefined sensations (e.g., preset shapes and/or outlines to be drawn as protrusions, preset thermal effects, preset texture effects, etc.) that a user may select to cause particular predefined sensation(s) to be included in the message being composed. Additionally or alternatively, sensation selection menu 615 may include one or more menu options that allow a user to define and/or otherwise create his or her own sensation to be included in the message.

For example, as seen in FIG. 6, if a user selects a menu option to draw a custom shape to be provided as a protrusion outline to a recipient of the message, the sensation selection menu 615 may include a prompt that instructs the user to draw the desired shape in an input region 618. Subsequently, the user may draw an outline of a shape 620 (e.g., on the touch-sensitive display 105 of the device 100 displaying the user interface 600). In at least one arrangement, the user may draw the outline of the shape 620 by placing his or her finger onto the screen of the device (e.g., the touch-sensitive display 105 of the device 100) at a touch point 625 and subsequently moving his or her finger to outline the shape 620, thereby causing the device 100 to detect the movement of the touch point 625 in the outline of the shape 620. In at least one additional arrangement, the device 100 may provide visual feedback to the user as the user draws the outline of the shape 620 by displaying one or more line segments and/or points 630 that illustrate the detected outline of the shape 620. In some arrangements, user interface 600 may include one or more regions and/or controls that enable a user to provide sensation input in additional and/or alternative ways. For example, user interface 600 may include one or more regions and/or controls that enable a user to provide sensation input using a peripheral device, such as a wand accessory. Additionally or alternatively, user interface 600 may include one or more regions and/or controls that enable a user to provide sensation input by performing one or more gestures, which may be detected by the computing device 100.

FIG. 7 illustrates an example data structure for transporting a sensation-enhanced message according to one or more illustrative aspects of the disclosure. As seen in FIG. 7, a data structure 700 for transporting a sensation-enhanced message may include a sender identifier field 705, a recipient identifier field 710, a text message field 715, and/or a haptic feedback field 720. In one or more arrangements, a data structure 700 may embody a sensation-enhanced message and may be configured to be sent from a sender device to a recipient device to cause the recipient device to display a message to a recipient user and/or to cause the recipient device to provide particular haptic feedback to the recipient user.

For example, sender identifier field 705 may be configured to store information identifying a sender of a sensation-enhanced message, such as the sender's name, telephone number, email address, and/or the like. Recipient identifier field 710 may be configured to store information identifying at least one intended recipient of the sensation-enhanced message, such as the at least one intended recipient's name, telephone number, email address, and/or the like. Text message field 715 may be configured to store information specifying text and/or characters to be provided to the at least one intended recipient of the sensation-enhanced message.

Additionally, haptic feedback field 720 may be configured to store information identifying one or more haptic sensations to be provided to the at least one intended recipient of the sensation-enhanced message (e.g., when the message is received and/or displayed). In at least one arrangement, and as seen in the example illustrated in FIG. 7, haptic feedback field 720 may be configured to store encoded haptic data, such as the haptic input encoded in step 525 of the example method discussed above with respect to FIG. 5. In some arrangements, haptic feedback field 720 may be further configured to store information specifying the location of one or more haptic components on the device on which the message was composed (and/or relative to this device). For example, haptic feedback field 720 may be configured to store a three-dimensional map of the one or more haptic components included in and/or connected to the device. The three-dimensional map may, for instance, define different regions of the device, the size of each region, and the haptic capabilities of each region (e.g., the haptic effects that can be reproduced and/or captured using sensors located in each particular region). This map information may, for instance, enable a device receiving the data structure to more accurately interpret the haptic data and/or reproduce the intended haptic feedback.

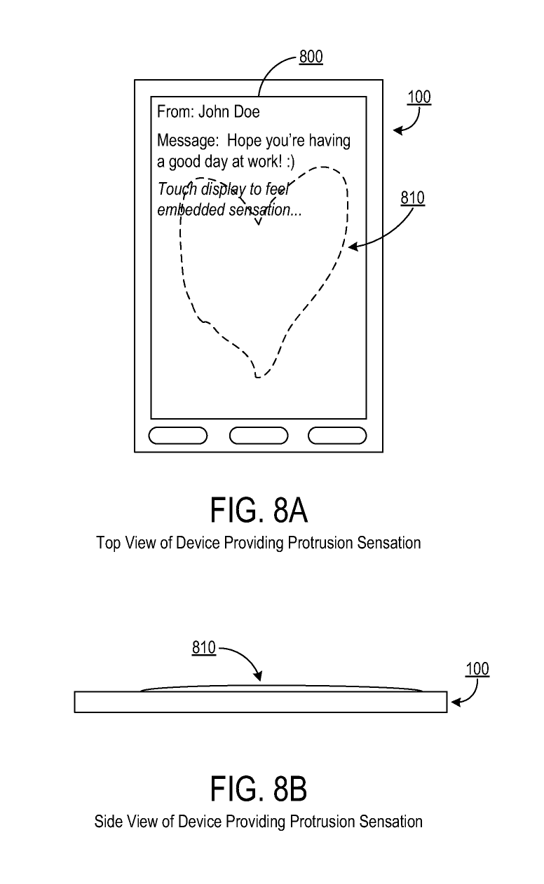

FIGS. 8A and 8B illustrate an example of a device displaying a sensation-enhanced message according to one or more illustrative aspects of the disclosure. For instance, as seen in FIG. 8A, after a computing device 100 receives a sensation-enhanced message, such as the sensation-enhanced message discussed in the examples above, the computing device 100 may display a user interface 800 that includes information identifying the sender of the message and/or information reflecting the text and/or character content of the message. Additionally or alternatively, the user interface 800 may prompt the user of the device 100 to touch and/or grip the device in a certain way in order to experience the one or more haptic sensations included in the message.

For instance, in an example in which a shape (e.g., an outline of a heart) is specified as haptic feedback to be provided in connection with a sensation-enhanced message, the device 100 may actuate one or more haptic components, such as haptic components 150 and 155, in order to create a protrusion 810 in accordance with the haptic data included in the message, such as a protrusion in the shape of a heart.

As seen in FIG. 8B, which illustrates a side view of the device 100 (e.g., at a time in which haptic sensation is provided), providing the haptic feedback may involve changing tactile properties of the device 100, such as deforming a top surface of the device 100 to create a protrusion 810 in the shape specified by the haptic data. Thus, when a user touches the surface of the device 100, the user may feel the edges of the protrusion 810, for example, in the outline of the shape. As discussed above, the deformation in the surface of the device 100 that creates the protrusion 810 (or the other features and effects specified by the haptic feedback) may be provided by one or more haptic components included in the device 100, such as haptic components 150 and 155.

As also discussed above, haptic feedback is something that may be missing from current mobile device platforms. By including such feedback, a new dimension in communication may be provided. Haptic feedback may include things that a human can feel (e.g., with their hand or hands), such as pressure, texture, pinching, heat, slip, shape, corners, and so on. Aspects of the disclosure relate to incorporating these sensations into cellular messaging services provided via mobile devices.

According to one or more aspects of the disclosure, sensation may be included in a cellular based messaging service that has wide availability. A user may choose one or more sensations from a plurality of sensations (e.g., poke, drawing a heart, sending a rhythmic beat, heat, etc.) to be provided to one or more recipients of a message. The selected sensation(s) may be encoded as metadata (e.g., in accordance with a particular or specific messaging service protocol) such that the sensation(s) can be delivered to a recipient mobile device for playback. Potential applications of these concepts include: allowing a user to send a drawing of a shape, such as a heart, to a portable device that the recipient can feel drawn on their hand when they receive a text message; allowing a sender to send a poke to a recipient to get the recipient's attention; and more.

In one or more configurations, sensation enhanced messaging may be deployed in SMS. For instance, a Short Message Service Center (SMSC) may transmit SMS messages to a handset. In one example method, sensation metadata may be encoded as part of an SMS message, thereby allowing for operation of sensation enhanced messaging without requiring changes to legacy infrastructure.

Additionally or alternatively, concatenated-SMS may be used to transmit additional sensation effects. For example, a particular bit field may be used to denote the beginning of a sensation encoding with a length field. The SMS client may then read the sensation metadata which may contain a sensation code and optionally a shape to be felt by the receiver. In one or more arrangements, the sensation data then would not be displayed as part of the text message, but instead decoded; an icon may be displayed to notify a user that sensation data is included with the text of the text message (e.g., and available for playback).

In one or more additional and/or alternative configurations, sensation enhanced messaging may be deployed in MMS. For example, a sending phone (or other computing device, e.g., computing device 100) may initiate a TCP/IP data connection. This may include the sending phone connecting to a Multimedia Messaging Service Center (MMSC) via TCP/IP. The sending phone may then perform an HTTP POST operation to the MMSC (e.g., via the TCP/IP connection) to post an MMS message. The MMS message may be encoded in MMS Encapsulation Format, e.g., as defined by the Open Mobile Alliance. The encoded MMS message may include the content of the MMS message (e.g., as composed by a user of the sending phone), as well as header information. The header information may include a list of intended recipients for the message, and may further include an identifier or value identifying the type(s) of sensation to be provided to the recipient(s) of the MMS message. Additionally or alternatively, the header information may include data encoding a polygon shape to be drawn as a sensation at the recipient device(s).

Subsequently, an MMSC may receive the sender's submission of the message and may validate the message sender. The MMSC then may store the contents of the MMS message and make the MMS message available to the recipient(s) as a dynamically generated URL link. In some arrangements, the dynamically generated URL link may correspond to both the sensation(s) selected by the sender and the other contents of the MMS message, while in other arrangements, the dynamically generated URL link might correspond only to the other contents of the MMS message and a second dynamically generated URL link may correspond to the sensation information defining the sensation(s) selected by the sender. In arrangements where a second URL link is dynamically generated to correspond to the sensation information, the recipient(s) and/or the recipient device(s) might request and/or obtain the second URL link only when playback of the selected sensation(s) is supported by the device(s) and/or when the recipient(s) requests to play back the sensation(s).

After the MMSC receives the sender's submission and/or dynamically generates the one or more corresponding URL links described above, the MMSC may generate an MMS notification message, which may be sent via WAP Push over SMS to the message recipient(s). In one or more arrangements, the MMS notification message may contain at least one URL pointer to the dynamically generated MMS content.

Subsequently, at least one recipient may receive the MMS notification message (e.g., from the MMSC). The at least one recipient's device may then initiate a data connection that provides, for instance, TCP/IP network connectivity. The at least one recipient's device then may use an HTTP GET command (and/or one or more other protocols and/or commands, such as a WSP get command) to retrieve the MMS message content URL (and the corresponding content) from the MMSC. Additionally or alternatively, the at least one recipient's device also may obtain a second URL corresponding to sensation information and/or otherwise defining sensation(s) to be played back with the MMS message.

More generally, various aspects of the disclosure describe how sensations may be added to message based communications to and between mobile devices. In one implementation, a peer-to-peer mode can be used to send sensation messages between portable devices. This could also apply in enabling a user to send a sensation from an email client to a recipient using SMS or in email messages themselves. In email implementations and/or in other implementations, sensations can be included as metadata in SMTP (e.g., in the SMTP headers associated with a message) or in the message body itself, such that the receiver can decode the sensation as metadata without displaying the haptic information defining the sensation (e.g., to the recipient user), but instead making the sensation and/or other haptic effects available to the recipient user.

Thus, one or more aspects of the disclosure describe and encompass choosing and/or otherwise selecting one or more haptic effects from a plurality of haptic effects (e.g., poke on finger, drawing a heart, heat, etc.) to be provided to one or more recipients when composing a message to be sent from one device to another using existing messaging technologies, such as SMS, MMS, SMTP, and/or the like.

One or more additional and/or alternative aspects of the disclosure describe and encompass choosing and/or otherwise selecting one or more haptic effects from a drop-down list of common sensations (e.g., a smiley face, a heart, a pinch, etc.) to be included in a message.

Still one or more additional and/or alternative aspects of the disclosure describe and encompass providing a draw pad, touch screen, or other means while a message is being composed so that a user can create (and thereby cause to be encoded) a shape to be reproduced on a receiver as a sensation (e.g., that can be played back on a recipient's palm).

In some additional and/or alternative implementations, sensation information may be encoded within Protocol Description Unit (PDU) format provided by SMS. In other additional and/or alternative implementations, sensation information may be made available at an alternative URL in MMS implementations (e.g., as described above). In still other additional and/or alternative implementations, sensation information may be encoded as SMTP metadata and/or in the body of an SMTP email message.

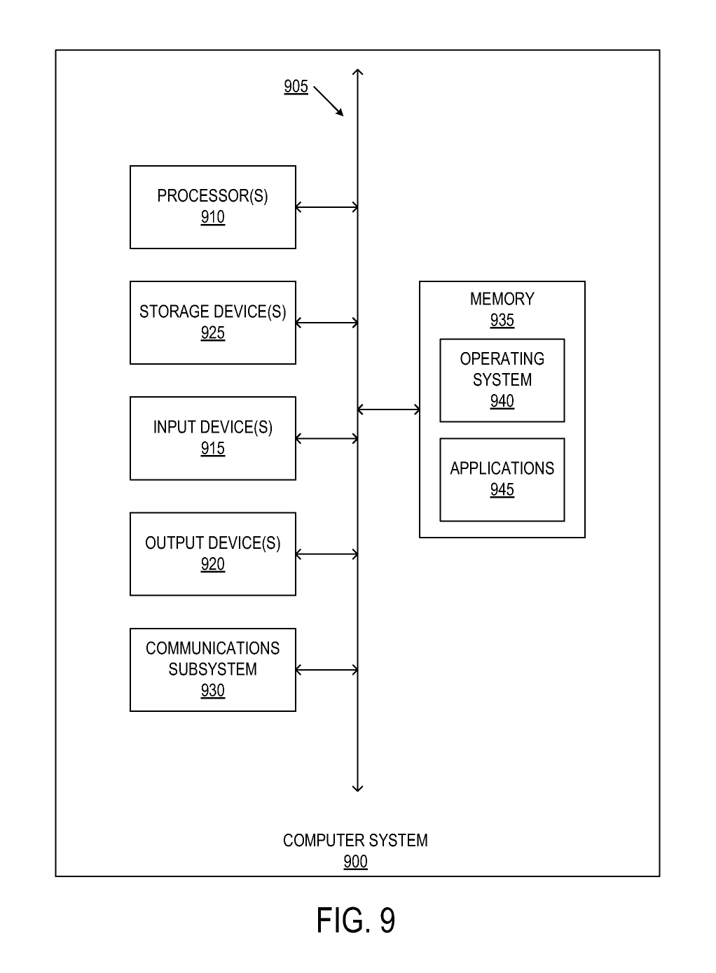

Having described multiple aspects of sensation enhanced messaging, an example of a computing system in which various aspects of the disclosure may be implemented will now be described with respect to FIG. 9. According to one or more aspects, a computer system as illustrated in FIG. 9 may be incorporated as part of a computing device, which may implement, perform, and/or execute any and/or all of the features, methods, and/or method steps described herein. For example, computer system 900 may represent some of the components of a hand-held device. A hand-held device may be any computing device with an input sensory unit, such as a camera and/or a display unit. Examples of a hand-held device include but are not limited to video game consoles, tablets, smart phones, and mobile devices. In one embodiment, the computer system 900 is configured to implement the device 100 described above. FIG. 9 provides a schematic illustration of one embodiment of a computer system 900 that can perform the methods provided by various other embodiments, as described herein, and/or can function as the host computer system, a remote kiosk/terminal, a point-of-sale device, a mobile device, a set-top box, and/or a computer system. FIG. 9 is meant only to provide a generalized illustration of various components, any and/or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a camera, a mouse, a keyboard and/or the like; and one or more output devices 920, which can include without limitation a display unit, a printer and/or the like.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 900 might also include a communications subsystem 930, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 930 may permit data to be exchanged with a network (such as the network described below, to name one example), other computer systems, and/or any other devices described herein. In many embodiments, the computer system 900 will further comprise a non-transitory working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 2, 3, and 5, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 900) to perform methods in accordance with the disclosure. For example, some or all of the procedures of the described methods may be performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein, for example a method described with respect to FIG. 2, FIG. 3, and/or FIG. 5.

The terms “machine-readable medium” and “computer-readable medium,” as used herein, refer to any medium that participates in providing data that causes a machine to operate in a specific fashion. In an embodiment implemented using the computer system 900, various computer-readable media might be involved in providing instructions/code to processor(s) 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 925. Volatile media include, without limitation, dynamic memory, such as the working memory 935. Transmission media include, without limitation, coaxial cables, copper wire and fiber optics, including the wires that comprise the bus 905, as well as the various components of the communications subsystem 930 (and/or the media by which the communications subsystem 930 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a non-transitory storage device 925 either before or after execution by the processor(s) 910.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
receiving an electronic message, the electronic message including sender-specified haptic data that identifies at least one non-vibratory haptic sensation to be provided to a recipient of the electronic message; and
causing haptic feedback to be provided based on the sender-specified haptic data.

2. The method of claim 1,
wherein the haptic feedback that is provided includes the at least one non-vibratory haptic sensation identified by the sender-specified haptic data.

3. The method of claim 1,
wherein the haptic feedback that is provided is different than the at least one non-vibratory haptic sensation identified by the sender-specified haptic data.

4. The method of claim 1, further comprising:
prior to causing the haptic feedback to be provided, determining, based on one or more user preferences, to provide at least one alternative haptic sensation instead of the at least one non-vibratory haptic sensation identified by the sender-specified haptic data.

5. The method of claim 1, further comprising:
prior to causing the haptic feedback to be provided, determining, based on device capability information, to provide at least one alternative haptic sensation instead of the at least one non-vibratory haptic sensation identified by the sender-specified haptic data.

6. The method of claim 1, further comprising:
prior to causing the haptic feedback to be provided, causing an indicator to be displayed, the indicator being configured to notify a user that the haptic feedback is available,
wherein the haptic feedback is caused to be provided in response to receiving a user selection of the indicator.

7. The method of claim 1, wherein the sender-specified haptic data was generated by a sender's device that received a selection of the at least one non-vibratory haptic sensation from a menu.

8. The method of claim 1,
wherein the at least one non-vibratory haptic sensation includes a protrusion in a particular shape.

9. The method of claim 8,
wherein the sender-specified haptic data was generated by a sender's device that received touch-based user input outlining the particular shape.

10. The method of claim 1, wherein the at least one non-vibratory haptic sensation includes one or more pressure characteristics, texture characteristics, wetness characteristics, adhesion characteristics, thermal characteristics, and/or movement characteristics.

11. The method of claim 1, wherein the sender-specified haptic data includes a haptic identifier corresponding to a particular non-vibratory haptic sensation.

12. The method of claim 1, wherein the at least one non-vibratory haptic sensation includes at least one haptic effect that is not produced by vibration.

13. The method of claim 1, wherein the haptic feedback is caused to be provided to a user of a device that received the electronic message.

14. At least one computer-readable medium storing computer-readable instructions that, when executed, cause at least one computing device to:
receive an electronic message, the electronic message including sender-specified haptic data that identifies at least one non-vibratory haptic sensation to be provided to a recipient of the electronic message; and
cause haptic feedback to be provided based on the sender-specified haptic data.

15. The at least one computer-readable medium of claim 14,
wherein the haptic feedback that is provided includes the at least one non-vibratory haptic sensation identified by the sender-specified haptic data.

16. The at least one computer-readable medium of claim 14,
wherein the haptic feedback that is provided is different than the at least one non-vibratory haptic sensation identified by the sender-specified haptic data.

17. The at least one computer-readable medium of claim 14, having additional computer-readable instructions stored thereon that, when executed, further cause the at least one computing device to:
prior to causing the haptic feedback to be provided, determine, based on one or more user preferences, to provide at least one alternative haptic sensation instead of the at least one non-vibratory haptic sensation identified by the sender-specified haptic data.

18. The at least one computer-readable medium of claim 14, having additional computer-readable instructions stored thereon that, when executed, further cause the at least one computing device to:
prior to causing the haptic feedback to be provided, determine, based on device capability information, to provide at least one alternative haptic sensation instead of the at least one non-vibratory haptic sensation identified by the sender-specified haptic data.

19. The at least one computer-readable medium of claim 14, having additional computer-readable instructions stored thereon that, when executed, further cause the at least one computing device to:
prior to causing the haptic feedback to be provided, cause an indicator to be displayed, the indicator being configured to notify a user that the haptic feedback is available,
wherein the haptic feedback is caused to be provided in response to receiving a user selection of the indicator.

20. The at least one computer-readable medium of claim 14, wherein the sender-specified haptic data was generated by a sender's device that received a selection of the at least one non-vibratory haptic sensation from a menu.

21. The at least one computer-readable medium of claim 14,
wherein the at least one non-vibratory haptic sensation includes a protrusion in a particular shape.

22. The at least one computer-readable medium of claim 21,
wherein the sender-specified haptic data was generated by a sender's device that received touch-based user input outlining the particular shape.

23. The at least one computer-readable medium of claim 14, wherein the at least one non-vibratory haptic sensation includes one or more pressure characteristics, texture characteristics, wetness characteristics, adhesion characteristics, thermal characteristics, and/or movement characteristics.

24. The at least one computer-readable medium of claim 14, wherein the sender-specified haptic data includes a haptic identifier corresponding to a particular non-vibratory haptic sensation.

25. The at least one computer-readable medium of claim 14, wherein the at least one non-vibratory haptic sensation includes at least one haptic effect that is not produced by vibration.

26. The at least one computer-readable medium of claim 14, wherein the haptic feedback is caused to be provided to a user of a device that received the electronic message.

27. An apparatus comprising:
at least one processor; and
memory storing computer-readable instructions that, when executed by the at least one processor, cause the apparatus to:
receive an electronic message, the electronic message including sender-specified haptic data that identifies at least one non-vibratory haptic sensation to be provided to a recipient of the electronic message; and
cause haptic feedback to be provided based on the sender-specified haptic data.

28. The apparatus of claim 27,
wherein the haptic feedback that is provided includes the at least one non-vibratory haptic sensation identified by the sender-specified haptic data.

29. The apparatus of claim 27,
wherein the haptic feedback that is provided is different than the at least one non-vibratory haptic sensation identified by the sender-specified haptic data.

30. The apparatus of claim 27, wherein the memory stores additional computer-readable instructions that, when executed by the at least one processor, further cause the apparatus to:
prior to causing the haptic feedback to be provided, determine, based on one or more user preferences, to provide at least one alternative haptic sensation instead of the at least one non-vibratory haptic sensation identified by the sender-specified haptic data.

31. The apparatus of claim 27, wherein the memory stores additional computer-readable instructions that, when executed by the at least one processor, further cause the apparatus to:
prior to causing the haptic feedback to be provided, determine, based on device capability information, to provide at least one alternative haptic sensation instead of the at least one non-vibratory haptic sensation identified by the sender-specified haptic data.

32. The apparatus of claim 27, wherein the memory stores additional computer-readable instructions that, when executed by the at least one processor, further cause the apparatus to:
prior to causing the haptic feedback to be provided, cause an indicator to be displayed, the indicator being configured to notify a user that the haptic feedback is available,
wherein the haptic feedback is caused to be provided in response to receiving a user selection of the indicator.

33. The apparatus of claim 27, wherein the sender-specified haptic data was generated by a sender's device that received a selection of the at least one non-vibratory haptic sensation from a menu.

34. The apparatus of claim 27,
wherein the at least one non-vibratory haptic sensation includes a protrusion in a particular shape.

35. The apparatus of claim 34,
wherein the sender-specified haptic data was generated by a sender's device that received touch-based user input outlining the particular shape.

36. The apparatus of claim 27, wherein the at least one non-vibratory haptic sensation includes one or more pressure characteristics, texture characteristics, wetness characteristics, adhesion characteristics, thermal characteristics, and/or movement characteristics.

37. The apparatus of claim 27, wherein the sender-specified haptic data includes a haptic identifier corresponding to a particular non-vibratory haptic sensation.

38. The apparatus of claim 27, wherein the at least one non-vibratory haptic sensation includes at least one haptic effect that is not produced by vibration.

39. The apparatus of claim 27, wherein the haptic feedback is caused to be provided to a user of the apparatus.

40. A system comprising:
means for receiving an electronic message, the electronic message including sender-specified haptic data that identifies at least one non-vibratory haptic sensation to be provided to a recipient of the electronic message; and
means for causing haptic feedback to be provided based on the sender-specified haptic data.

41. The system of claim 40,
wherein the haptic feedback that is provided includes the at least one non-vibratory haptic sensation identified by the sender-specified haptic data.

42. The system of claim 40,
wherein the haptic feedback that is provided is different than the at least one non-vibratory haptic sensation identified by the sender-specified haptic data.

43. The system of claim 40, further comprising:
means for determining, prior to causing the haptic feedback to be provided and based on one or more user preferences, to provide at least one alternative haptic sensation instead of the at least one non-vibratory haptic sensation identified by the sender-specified haptic data.

44. The system of claim 40, further comprising:
means for determining, prior to causing the haptic feedback to be provided and based on device capability information, to provide at least one alternative haptic sensation instead of the at least one non-vibratory haptic sensation identified by the sender-specified haptic data.

45. The system of claim 40, further comprising:
means for causing, prior to causing the haptic feedback to be provided, an indicator to be displayed, the indicator being configured to notify a user that the haptic feedback is available,
wherein the haptic feedback is caused to be provided in response to receiving a user selection of the indicator.

46. The system of claim 40, wherein the sender-specified haptic data was generated by a sender's device that received a selection of the at least one non-vibratory haptic sensation from a menu.

47. The system of claim 40,
wherein the at least one non-vibratory haptic sensation includes a protrusion in a particular shape.

48. The system of claim 47,
wherein the sender-specified haptic data was generated by a sender's device that received touch-based user input outlining the particular shape.

49. The system of claim 40, wherein the at least one non-vibratory haptic sensation includes one or more pressure characteristics, texture characteristics, wetness characteristics, adhesion characteristics, thermal characteristics, and/or movement characteristics.

50. The system of claim 40, wherein the sender-specified haptic data includes a haptic identifier corresponding to a particular non-vibratory haptic sensation.

51. The system of claim 40, wherein the at least one non-vibratory haptic sensation includes at least one haptic effect that is not produced by vibration.

52. The system of claim 40, wherein the haptic feedback is caused to be provided to a user of the system.
